(19) United States
(12) Patent Application Publication
(10) Pub. No.: US 2020/0146090 A1
(43) Pub. Date: May 7, 2020

(54) WIRELESS COMMUNICATION SYSTEM AND METHOD FOR RELOCATING CONTROL PLANE MANAGEMENT NODE OF USER EQUIPMENT

(71) Applicant: Institute For Information Industry, Taipei (TW)

(72) Inventors: Chun-Yen HSU, Taipei City (TW); Tzu-Ya WANG, Taipei City (TW)

(21) Appl. No.: 16/221,164

(22) Filed: Dec. 14, 2018

(30) Foreign Application Priority Data
Nov. 1, 2018 (TW) 107138817

(51) Int. Cl. H04W 76/22; H04W 8/08; H04W 36/10; H04W 24/04

(52) U.S. Cl. CPC H04W 76/22; H04W 24/04; H04W 36/10; H04W 8/082

(57) ABSTRACT

A method for relocating control plane management node of a user equipment includes: a first control plane management node coupled with a base station requesting from a second control plane management node for its connection information; and without releasing network connection of the user equipment, the first control plane management node commanding a user equipment coupled with the base station to update its connection information, so that a second control plane management node manages control plane of the user equipment instead of the first control plane management node.

### PRIORITY

This application claims priority to Taiwan Patent Application No. 107138817 filed on Nov. 1, 2018, which is hereby incorporated by reference in its entirety.

### FIELD

Embodiments of the present invention relate to a wireless communication system. More particularly, the embodiments of the present invention relate to a wireless communication system and a method for relocating control plane management node of a user equipment.

### BACKGROUND

Conventional wireless communication systems comprise a user equipment, a base station, and a core network which may comprise a control plane management node for managing control plane of the user equipment, a user plane management node for managing user plane of the user equipment, and a user plane node for transmitting user data packets. For example, in the 3rd Generation Partnership Project (3GPP) Long Term Evolution (LTE) mobile communication system (generally called 4G Mobile Communication System), the control plane management node is a Mobility Management Entity (MME), and the user plane management node and the user plane node are collocated in the Serving Gateway (S-GW). For another example, in 5G Mobile Communication System, the control plane management node is a device having an Access and Mobility Management Function (AMF), the user plane management node is a device having a Session Management Function (SMF), and the user plane node is a device having a User Plane Function (UPF).

In 4G Mobile Communication System, the control plane of the user equipment is connected to a MME assigned by the system, and the MME is responsible for managing the control plane of the user equipment. In addition, the user plane of the user equipment is connected to an S-GW assigned by the system, and the S-GW is responsible for managing the user plane of the user equipment. Due to load balancing and maintenance need for example, it may be desirable to relocate the control plane management node of the user equipment being in the Radio Resource Control (RRC) connected state from the current MME (hereinafter referred to as “original MME”) to another MME (hereinafter referred to as a “target MME”). To relocate the control plane management node of the user equipment, the original MME will first provide the user equipment a new Globally Unique Temporary Identifier (GUTI) associated with the target MME and then releases its network resources to release the network connection of the user equipment. After that, the user equipment which has become RRC idle state from RRC connected state requests for re-establish the connection with the network by sending the connection request message including the new GUTI to the base station, and the base station will then select the target MME according to the new GUTI associated with the target MME received from the user equipment. Next, the base station requests the target MME to manage the control plane of the user equipment. Finally, the target MME commands the S-GW to setup the user plane of the user equipment so that the user equipment can continue to receive and transmit data packet again.

When the user equipment enters the RRC idle state, both control plane and user plane connection of the user equipment will be released and thus the connection between the user equipment and the core network is interrupted, and the data cannot be transmitted therebetween normally. Such connection-interruption issue also exist in 5G Mobile Communication System.

In order to prevent user experience from being impacted during control plane management node relocation, it is important in the art regarding how to complete the control plane management node relocation without interrupting the connection between the user equipment and the core network.

### SUMMARY

Provided is a wireless communication system, which may comprise a user equipment, a base station, a first control plane management node, and a second control plane management node. The base station is connected to the user equipment, the first control plane management node, and the second control plane management node respectively, and the first control plane management node is connected to the second control plane management node. The first control plane management node is originally configured to manage control plane of the user equipment. The first control plane management node may be configured to request connection information of the second control plane management node from the second control plane management node, and command the user equipment to update its connection information so that the second control plane management node replaces the first control plane management node to manage the control plane of the user equipment without releasing network connection of the user equipment.

Also provided is a method for relocating control plane management node of a user equipment, which may comprise:

requesting, by a first control plane management node connected to a base station, connection information of a second control plane management node from the second control plane management node; and commanding a user equipment connected to the base station to update its connection information by the first control plane management node according to the connection information of the second control plane management node so that the second control plane management node replaces the first control plane management node to manage control plane of the user equipment without releasing network connection of the user equipment.

Because the first control plane management node can obtain the connection information of the second control plane management node from the second control plane management node, the first control plane management node is capable of directly commanding the user equipment to update its connection information without releasing network resources (i.e., without releasing the connection between the first control plane management node and the user equipment). In the process of relocating the control plane management node of the user equipment from the first control plane management node to the second control plane management node, because the first control plane management node does not release network resources, the user equipment can always stay in the RRC connected state. In other words, in the process of relocating the control plane management node of the user equipment from the first control plane management node to the second control plane management node, the connection between the user equipment and the core network can be maintained.

What described above is not intended to limit the present invention, but only generally describes the technical problem that can be solved by the present invention, the technical means that can be adopted and the technical effect that can be achieved so that a person having ordinary skill in the art can preliminarily understand the present invention. Details of the embodiments of the present invention can be further understood by a person having ordinary skill in the art according to attached drawings and contents recorded in the following description of the preferred embodiments.

### BRIEF DESCRIPTION OF THE DRAWINGS

FIG. 1A illustrates a schematic view of a wireless communication system according to some embodiments.

FIG. 1B illustrates a schematic view of another wireless communication system according to some embodiments.

FIG. 2 illustrates a schematic view of relocating control plane management node of a user equipment in the wireless communication system shown in FIG. 1A and FIG. 1B according to some embodiments.

FIG. 3 illustrates a schematic view of a method of relocating control plane management node of a user equipment according to some embodiments.

### DETAILED DESCRIPTION

The present invention will be described hereinafter with reference to example embodiments thereof. However, these example embodiments are not intended to limit that the present invention can only be implemented according to the operations, environment, applications, structures, processes or steps described in these example embodiments. In the attached drawings, elements unrelated to the present invention are omitted from depiction, but may be implied by the attached drawings, and dimensions of elements and proportional relationships among individual elements in the attached drawings are only exemplary examples but not intended to limit the present invention. Unless stated particularly, same (or similar) element symbols may correspond to same (or similar) elements in the following description. Unless stated specifically, the number of each element described hereinafter may be one or more while it can be implemented.

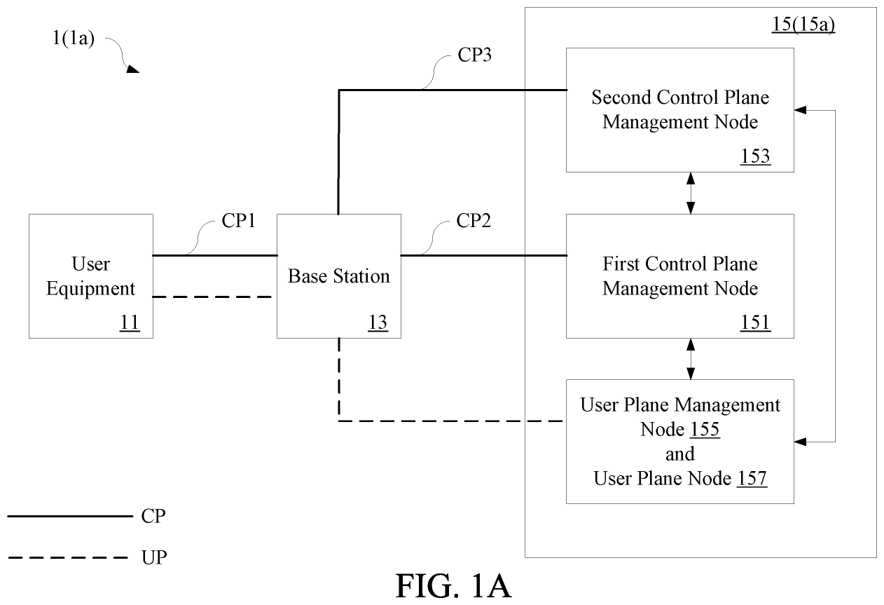

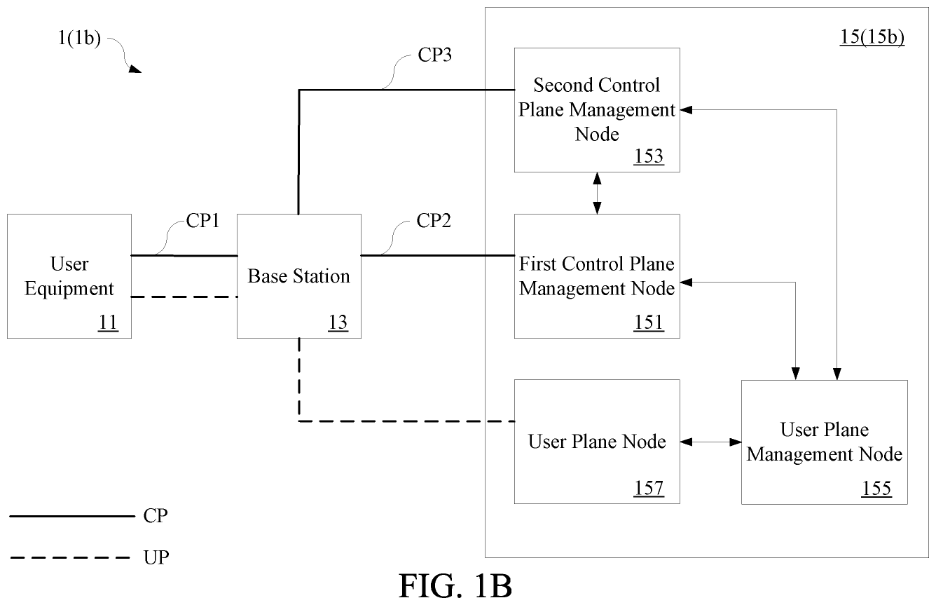

FIG. 1A illustrates a schematic view of a wireless communication system under the architecture of 4G Mobile Communication System according to some embodiments, while FIG. 1B illustrates a schematic view of a wireless communication system under the architecture of 5G Mobile Communication System according to some embodiments. The contents shown in FIG. 1A and FIG. 1B are only for illustrating embodiments of the present invention rather than for limiting the present invention.

Referring to FIG. 1A and FIG. 1B, the wireless communication system 1 may basically comprise a user equipment 11, a base station 13, and a core network 15 which may basically comprise a first control plane management node 151, a second control plane management node 153, a user plane management node 155, and a user plane node 157.

The wireless communication system 1 may be a wireless communication system applied to various communication technologies. For example, in as shown in FIG. 1A, the wireless communication system 1 may be a wireless communication system 1a which is applied to 4G Mobile Communication System. In this case, the core network 15 is a core network 15a of 4G Mobile Communication System, each of the first control plane management node 151 and the second control plane management node 153 is an MME, and the combination of the user plane management node 155 and the user plane node 157 is an S-GW. The base station 13 is connected to the user equipment 11, the first control plane management node 151, and the second control plane management node 153 respectively. In addition, the base station 13 is connected to the combination of the user plane management node 155 and the user plane node 157. In the core network 15a, the first control plane management node 151, the second control plane management node 153, and the combination of the user plane management node 155 and the user plane node 157 are connected to each other.

In another example, as shown in FIG. 1B, the wireless communication system 1 may be a wireless communication system 1b which is applied to 5G Mobile Communication System. The difference between the wireless communication system 1b and the wireless communication system 1a is that the core network 15 of the wireless communication system 1b is a core network 15b of 5G Mobile Communication System, each of the first control plane management node 151 and the second control plane management node 153 in the core network 15b may be a device having an Access and Mobility Management Function (AMF), the user plane management node 155 may be a device having a Session Management Function (SMF), and the user plane node 157 may be a device having a User Plane Function (UPF). The base station 13 is connected to the user equipment 11, the first control plane management node 151, and the second control plane management node 153 respectively. Further, the base station 13 is connected to the user plane node 157. In the core network 15b, the first control plane management node 151, the second control plane management node 153, and the user plane management node 155 are mutually connected to each other. The user plane management node 155 is connected to the user plane node 157. The basic architecture and functions of the core network 15a belonging to 4G Mobile Communication System and the core network 15b belonging to 5G Mobile Communication System are known by a person having ordinary skill in the art, and thus will not be described in detail.

In addition, depending on different applications, the user equipment 11 and the base station 13 may be presented in different types. For example, without any limitations, the user equipment 11 may be an electronic device such as a smart phone, a tablet computer, a notebook computer, or a desktop computer. For example, without any limitations, the base station 13 may be a base station such as a Macrocell, a Microcell, or a Picocell.

The user equipment 11, the base station 13 and the core network 15 may use the control plane CP to transmit various control messages among them and use the user plane UP to transmit various user data among them. Under the management of the first control plane management node 151, the control plane CP may comprise a control plane CP1 (i.e., the control plane CP1 between the user equipment 11 and the base station 13) and a control plane CP2 (i.e., the control plane CP2 between the base station 13 and the first control plane management node 151 in the core network 15). Under the management of the second control plane management node 153, the control plane CP may comprise the control plane CP1 (i.e., the control plane CP1 between the user equipment 11 and the base station 13) and a control plane CP3 (i.e., the control plane CP3 between the base station 13 and the second control plane management node 153 in the core network 15). Under the management of the user plane management node 155, the user plane UP may comprise a user plane between the user equipment 11 and the base station 13, and a user plane between the base station 13 and the combination of the user plane management node 155 and the user plane node 157 in the core network 15a or between the base station 13 and the user plane node 157 in the core network 15b. The first control plane management node 151, the second control plane management node 153, and the user plane management node 155 in the core network 15 may be connected to each other directly or indirectly, and communicate and transmit signals with each other, and so on.

According to different requirements, the connection relationships mentioned in FIG. 1A and FIG. 1B may be direct connections (i.e., not connected to each other via other specific functional elements) or indirect connections (i.e., connected to each other via other specific functional elements).

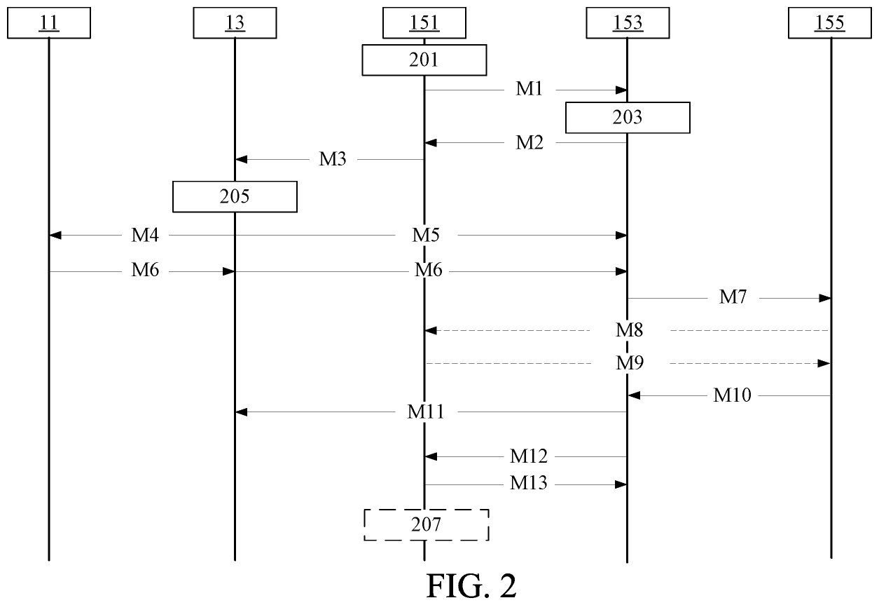

FIG. 2 illustrates a schematic view of relocating control plane management node of the user equipment in the wireless communication system 1a of FIG. 1A and the wireless communication system 1b of FIG. 1B according to some embodiments. The contents shown in FIG. 2 are only for illustrating embodiments of the present invention rather than for limiting the present invention.

Referring to FIG. 1A and FIG. 2, or FIG. 1B and FIG. 2, it is assumed that the first control plane management node 151 is originally configured to manage the control plane CP of the user equipment 11 (i.e., the control plane CP2 and the control plane CP1). First, the first control plane management node 151 may decide whether to relocate the control plane management node of the user equipment 11 from itself to the second control plane management node 153 so that the second control plane management node 153 replaces the first control plane management node 151 to manage the control plane CP of the user equipment 11 (shown as operation 201).

Next, the first control plane management node 151 may transmit a relocation request message M1 to the second control plane management node 153 when it decides to relocate the user equipment 11 to the second control plane management node 153, wherein the relocation request message M1 may comprise the relevant parameters required for the first control plane management node 151 to manage the base station 13 and the user equipment 11. For example, the relocation request message M1 may include: an International Mobile Subscriber Identity (IMSI), a Globally Unique Temporary Identifier (GUTI), a base station identifier, an original connection-related identifier of the user equipment (for example, an original eNB UE S1AP ID, or an original RAN UE NGAP ID), a user plane management node identifier (for example, a SGW ID, or a SMF ID), user equipment bearer information, security context, and so on. Detailed description for the parameters mentioned herein can be found in the latest version of 3GPP TS 36.401 and 3GPP TS 38.401 specifications.

After the second control plane management node 153 receives the relocation request message M1 transmitted by the first control plane management node 151, the second control plane management node 153 may assign identifiers which are required for connection to the second control plane management node 153 to the user equipment 11, and accordingly generates connection information of second control plane management node 153. The connection information of second control plane management node 153 may comprise: a new GUTI, and a new connection-related identifier of the user equipment (for example, a new MME UE S1AP ID, or a new AMF UE NGAP ID) (shown as operation 203). Then, the second control plane management node 153 may transmit a relocation response message M2 carried with the connection information of second control plane management node 153 to the first control plane management node 151. The relocation response message M2 may comprise at least: an IMSI, a new GUTI and a new connection-related identifier of the user equipment (for example, the new MME UE S1AP ID, or the new AMF UE NGAP ID), etc.

After receiving the relocation response message M2, the first control plane management node 151 may transmit a relocation command message M3 to the base station 13 to command the base station 13 to connect to the second control plane management node 153. The relocation command message M3 may comprise: original connection-related identifiers of the user equipment (for example, an original MME UE S1AP ID and an original eNB UE S1AP ID, or an original AMF UE NGAP ID and an original RAN UE NGAP ID), a second control plane management node address, a new connection-related identifier of the user equipment (for example, the new MME UE S1AP ID, or the new AMF UE NGAP ID), ID relocation NAS message, and the like. The ID relocation NAS message may carry the new GUTI.

After receiving the relocation command message M3, the base station 13 may assign a new connection-related identifier of the user equipment (for example, a new eNB UE S1AP ID, or a new RAN UE NGAP ID) to the user equipment 11 (shown as operation 205). The base station 13 may then transmit an ID relocation message M4 carried with the new GUTI to the user equipment 11.

After performing operation 205, the base station 13 may further transmit a relocation notification message M5 to the second control plane management node 153 to provide information related to how to connecting the second control plane management node 153 and the user equipment 11. For example, the relocation notification message M5 may comprise: new connection-related identifiers of the user equipment (for example, the new eNB UE S1AP ID and the new MME UE S1AP ID, or the new RAN UE NGAP ID and the new AMF UE NGAP ID), an original connection-related identifier of the user equipment (for example, the original eNB UE S1AP ID, or the original RAN UE NGAP ID).

After receiving the ID relocation message M4, the user equipment 11 may update its identifier (for example, the new eNB UE S1AP ID, or the new RAN UE NGAP ID). Then, the user equipment 11 may transmit an ID relocation complete message M6 to the second control plane management node 153 through the base station 13 (i.e., the user equipment 11 transmits the ID relocation complete message M6 to the base station 13, and then the base station 13 transfer the ID relocation complete message M6 to the second control plane management node 153).

After receiving the relocation notification message M5 and the ID relocation complete message M6, a control plane CP3 between the second control plane management node 153 and the base station 13 may be established. At this time, the second control plane management node 153 may replace the first control plane management node 151 to manage the control plane CP of the user equipment 11 (that is, managing the control plane CP1 and the control plane CP3). Next, the second control plane management node 153 may transmit a modifying session request message M7 to the user plane management node 155 to command the user plane management node 155 to modify a session configuration. For example, the modifying session request message M7 may comprise: an IMSI, a second control plane management node identifier (for example, a new MME ID, or a new AMF ID). After receiving the modifying session request message M7, the user plane management node 155 may modify the session configuration and return a modifying session response message M10 to the second control plane management node 153 after modifying the session configuration, wherein the modifying session response message M10 may comprise an IMSI.

In some embodiments, optionally, after the second control plane management node 153 transmits the modify session request message M7 to the user plane management node 155 and before the user plane management node 155 returns the modifying session response message M10 to the second control plane management node 153, the user plane management node 155 may further transmit a modifying session query message M8 to the first control plane management node 151 and confirm whether the first control plane management node 151 agrees to relocate the user equipment 11 to the second control plane management node 153 according to a modifying session query response message M9 returned by the first control plane management node 151.

After the second control plane management node 153 receives the modifying session response message M10 transmitted by the user plane management node 155, the second control plane management node 153 may transmit a relocation ACK message M11 to the base station 13 to respond to the relocation notification message M5 transmitted by the base station 13.

After transmitting the relocation ACK message M11, the second control plane management node 153 may transmit a relocation complete message M12 to the first control plane management node 151 to inform the first control plane management node 151 that the relocation of the user equipment 11 has been completed. Correspondingly, the first control plane management node 151 may return a relocation ACK message M13 to the second control plane management node 153. After the relocation ACK message M13 is returned, the first control plane management node 151 may optionally release the network resources (shown as operation 207). After the first control plane management node 151 releases the network resources, the control plane CP2 between the base station 13 and the first control plane management node 151 is also released.

In some embodiments, the modifying session request message M7 may be transmitted before the transmissions of the relocation ACK message M11, the relocation complete message M12, and the relocation ACK message M13.

In some embodiments, if the user equipment 11 transmits Non Access Stratum (NAS) messages (i.e., NAS PDU) to the first control plane management node 151 through the base station 13 during the process of relocating the user equipment 11 from the first control plane management node 151 to the second control plane management node 153, the first control plane management node 151 may redirect the NAS messages to the second control plane management node 153 before releasing the network resources of the first control plane management node 151. After the user equipment 11 is relocated from the first control plane management node 151 to the second control plane management node 153, the NAS messages will be processed by the second control plane management node 153.

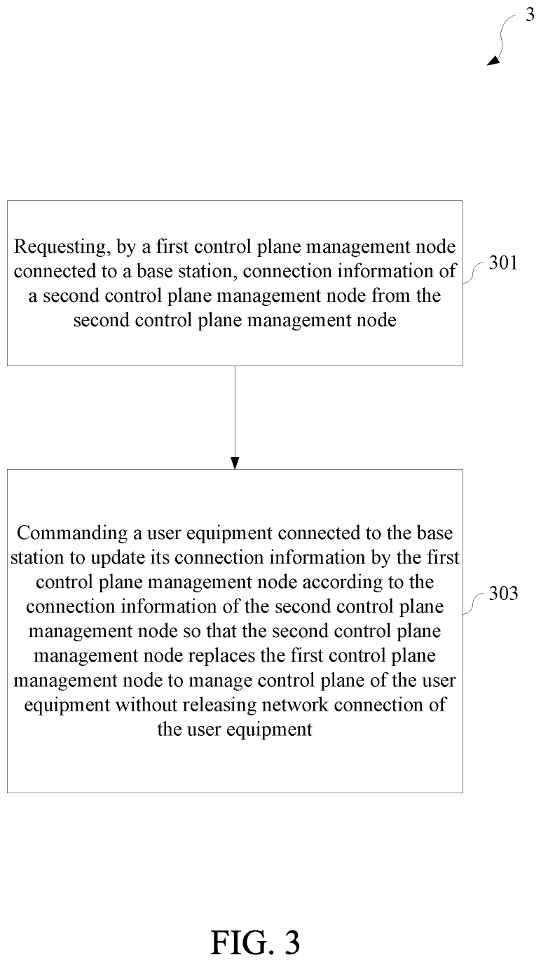

FIG. 3 illustrates a schematic view of a method for relocating control plane management node of a user equipment in according to some embodiments. The contents shown in FIG. 3 are only for illustrating embodiments of the present invention rather than for limiting the present invention.

Referring to FIG. 3, a method 3 for relocating control plane management node of a user equipment may comprise the following steps:

requesting, by a first control plane management node connected to a base station, connection information of a second control plane management node from the second control plane management node (shown as step 301); and commanding a user equipment connected to the base station to update its connection information by the first control plane management node according to the connection information of the second control plane management node so that the second control plane management node replaces the first control plane management node to manage control plane of the user equipment without releasing network connection of the user equipment (shown as step 303).

The order in which the steps 301 and 303 of FIG. 3 are executed is not limited. The order in which the steps 301 and 303 of FIG. 3 are executed may be adjusted in the case while it can still be implemented.

In some embodiments, in addition to steps 301 and 303, the method 3 for relocating control plane management node of the user equipment may further comprise the following step:

commanding, by the second control plane management node, a user plane management node connected to the second control plane management node to modify a session configuration after the second control plane management node replaces the first control plane management node.

In some embodiments, in addition to steps 301 and 303, the method 3 for relocating control plane management node of the user equipment may further comprise the following steps:

commanding, by the second control plane management node, a user plane management node connected to the second control plane management node to modify a session configuration after the second control plane management node replaces the first control plane management node; and

releasing, by the first control plane management node, network resources after the user plane management node modifies the session configuration.

In some embodiments, in addition to steps 301 and 303, the method 3 for relocating control plane management node of the user equipment may further comprise the following steps:

commanding, by the second control plane management node, a user plane management node connected to the second control plane management node to modify a session configuration after the second control plane management node replaces the first control plane management node;

releasing, by the first control plane management node, network resources after the user plane management node modifies the session configuration; and

redirecting, by the first control plane management node, Non Access Stratum (NAS) messages of the user equipment to the second control plane management node before the first control plane management node releases the network resources.

In some embodiments, the method 3 for relocating control plane management node of the user equipment may apply to 4G Mobile Communication System, and each of the first control plane management node and the second control plane management node is a mobility management entity.

In some embodiments, the method 3 for relocating control plane management node of the user equipment may apply to 5G Mobile Communication System, and each of the first control plane management node and the second control plane management node has an access and mobility management function.

In some embodiments, all of the aforesaid steps of the method 3 for relocating control plane management node of the user equipment may be executed by the wireless communication system 1. In addition to the aforesaid steps, the method 3 for relocating control plane management node of the user equipment may also comprise other steps corresponding to all of the aforesaid embodiments of the wireless communication system 1. These other steps can be appreciated by a person having ordinary skill in the art depending on the above description for the wireless communication system 1, and thus will not be further described herein.

The above disclosure is related to the detailed technical contents and inventive features thereof. A person having ordinary skill in the art may proceed with a variety of modifications and replacements according to the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A wireless communication system, comprising:
a user equipment;
a base station connected to the user equipment;
a first control plane management node connected to the base station, and configured to manage control plane of the user equipment; and
a second control plane management node connected to the base station and the first control plane management node respectively;
wherein the first control plane management node is also configured to request connection information of the second control plane management node from the second control plane management node, and command the user equipment to update its connection information so that the second control plane management node replaces the first control plane management node to manage the control plane of the user equipment without releasing network connection of the user equipment.

2. The wireless communication system of claim 1, further comprising a user plane management node, wherein:
the user plane management node is connected to the second control plane management node, and configured to manage user plane of the user equipment; and
the second control plane management node further commands the user plane management node to modify a session configuration after the second control plane management node replaces the first control plane management node.

3. The wireless communication system of claim 2, wherein the first control plane management node releases the network connection of the user equipment after the user plane management node modifies the session configuration.

4. The wireless communication system of claim 3, wherein the first control plane management node further redirects Non Access Stratum (NAS) messages of the user equipment to the second control plane management node before the first control plane management node releases the network connection of the user equipment.

5. The wireless communication system of claim 1, wherein the wireless communication system is 4G Mobile Communication System, and each of the first control plane management node and the second control plane management node is a Mobility Management Entity (MME).

6. The wireless communication system of claim 1, wherein the wireless communication system is 5G Mobile Communication System, and each of the first control plane management node and the second control plane management node has an Access and Mobility Management Function (AMF).

7. A method for relocating control plane management node of a user equipment, comprising:
requesting, by a first control plane management node connected to a base station, connection information of a second control plane management node from the second control plane management node; and
commanding a user equipment connected to the base station to update its connection information by the first control plane management node according to the connection information of the second control plane management node so that the second control plane management node replaces the first control plane management node to manage control plane of the user equipment without releasing network connection of the user equipment.

8. The method for relocating control plane management node of the user equipment of claim 7, further comprising:
commanding, by the second control plane management node, a user plane management node connected to the second control plane management node to modify a session configuration after the second control plane management node replaces the first control plane management node.

9. The method for relocating control plane management node of the user equipment of claim 8, further comprising:
releasing, by the first control plane management node, the network connection of the user equipment after the user plane management node modifies the session configuration.

10. The method for relocating control plane management node of the user equipment of claim 9, further comprising:
redirecting, by the first control plane management node, Non Access Stratum (NAS) messages of the user equipment to the second control plane management node before the first control plane management node releases the network connection of the user equipment.

11. The method for relocating control plane management node of the user equipment of claim 7, wherein the method applies to 4G Mobile Communication System, and each of the first control plane management node and the second control plane management node is a Mobility Management Entity (MME).

12. The method for relocating control plane management node of the user equipment of claim 7, wherein the method applies to 5G Mobile Communication System, and each of the first control plane management node and the second control plane management node has an Access and Mobility Management Function (AMF).
